(19) United States
(12) Patent Application Publication
(10) Pub. No.: US 2022/0156322 A1
(43) Pub. Date: May 19, 2022

(54) GRAPH REORDERING AND TILING TECHNIQUES

(71) Applicant: Intel Corporation, Santa Clara, CA (US)

(72) Inventors: Tarjinder SINGH, Bangalore (IN); Sridhar SR, Bangalore (IN); Ranga SUMIRAN, Bengaluru (IN); Bakshree MISHRA, Bhubaneswar (IN); Srajudheen MAKKADAYIL, Bangalore (IN); Vidhya THYAGARAJAN, Bangalore (IN); Vijayavardhan BAIREDDY, Hyderabad (IN)

(21) Appl. No.: 17/533,976

(22) Filed: Nov. 23, 2021

(30) Foreign Application Priority Data
Sep. 29, 2021 (IN) 202141044106

(51) Int. Cl. G06F 16/901

(52) U.S. Cl. CPC G06F 16/9024; G06F 16/9014

(57) ABSTRACT

Graph reordering and tiling techniques are described herein. In one example, large graphs (e.g., for inferencing with graph neural networks) can be reordered, tiled, or both, to achieve maximal data reuse and uniform compute load distribution. In one example, a reordering method involves performing breadth first search (BFS) renumbering on a graph data set with the highest degree destination node as the root node to generate a reordered graph data set. BFS is then performed again with candidate nodes from the last level of the reordered graph. The second reordered graph data set with the lowest bandwidth or best profile can be selected for further processing. In one example, a method of tiling involves dividing a graph data set into tiles to balance expected compute time.

### RELATED APPLICATION

This application claims priority from Indian Provisional Patent Application No. 202141044106, entitled, “METHOD AND APPARATUS FOR INFERENCING OF LARGE GRAPH NEURAL NETWORKS WITH MAXIMAL DATA REUSE AND UNIFORM COMPUTE LOAD DISTRIBUTION,” filed Sep. 29, 2021, in the Indian Patent Office, the entire contents of which is incorporated by reference in its entirety.

### FIELD

This disclosure relates generally to neural networks and some examples relate more particularly to graph reordering and tiling techniques for inferencing with large graph neural networks.

### BACKGROUND OF THE DISCLOSURE

Recent developments in hardware for machine learning (ML) focus on optimizing dense compute such as General Matrix Multiply (GEMMS) and convolutional neural networks (CNNs). For regular CNNs and recurrent neural networks (RNNs), the input data (e.g., image or text) typically include highly structured and sequential data. Graph Neural Networks (GNNs) are a type of Deep Neural Networks (DNNs) that provide useful information from graph data. GNNs may be applied to many applications, such as recommender systems, drug discovery, fraud detection, protein and drug interaction, road traffic control, placement and route automation in chip design, and other applications. Some of the popular implementations of GNNs are GraphSAGE, Graph Convolutional Neural Network, Graph Attention Networks, PinSAGE, and Ali-Graph.

### BRIEF DESCRIPTION OF THE DRAWINGS

So that the manner in which the features of the present embodiments can be understood in detail, a more particular description of the embodiments, briefly summarized above, may be had by reference to embodiments, some of which are illustrated in the appended drawings. Itis to be noted, however, that the appended drawings illustrate only typical embodiments and are therefore not to be considered limiting of its scope.

FIG. 1 illustrates an example of the spread-width of an adjacency matrix.

FIG. 2A shows an example of a higher-level memory view.

FIG. 2B shows an example of an operating set of graphs in local memory.

FIG. 3A is a flow chart of an example of a method of performing a graph reordering technique.

FIG. 3B is a flow chart of an example of a method of assigning numbers to destination nodes.

FIG. 4 illustrates an example of a graph with numbers assigned in accordance with the method of FIG. 3B.

FIG. 5A shows an example of a sample random adjacency matrix.

FIG. 5B shows an example of the reordered version with a single breadth first search (BFS).

FIG. 5C shows an example of an adjacency matrix after performing BFS reordering with a candidate node as the root node.

FIG. 6 illustrates an example of a tile descriptor.

FIG. 7 is a table of an example of unique source node embeddings per tile.

FIG. 8 is a flowchart of an example of a method of tiling.

FIGS. 9A-9C show an example of conversion of a reordered graph to CBT tiles.

FIG. 10 is a flow chart of an example of a method of tile stripe ID-based reordering.

FIGS. 11A-11B illustrates an example of application-selected nodes before and after reordering based on tile stripe ID.

FIG. 12 depicts a compute platform such as a server or similar computing system in which techniques described herein may be implemented.

### DETAILED DESCRIPTION

Unlike regular deep neural networks (DNNs) (such as convolutional neural networks (CNNs) and recurrent neural networks (RNNs)), which typically operate on text, speech, and image data, graph neural networks (GNNs) take graphs as inputs. A graph is a data structure consisting of vertices and edges. An edge represents a connection between two vertices.

Graphs typically have highly irregular and non-Euclidean data. A graph dataset typically includes two components: a) connectivity information provided in the form of adjacency matrices in a compressed form (such as COO, CSR, CSC, or other compressed form) or adjacency lists, and b) embedding information corresponding to every vertex and/or edges in the graph. In one example, a vertex includes multiple features or information represented as embeddings. For example, a 256-byte embedding can have 256 1-byte values, a 2408-byte embedding can have 602 4-byte embeddings, etc. Embeddings are typically a higher dimensional representation of input data, for example outputs of word2vec network and outputs of intermediate layers of CNNs for image inputs.

Graph Neural Networks running on a graph dataset typically involve two steps that are common across GNN algorithms: 1) aggregation: collecting and aggregating embeddings of neighbors of vertices based on connectivity information, and 2) combination: applying one or more neural network layers (multiplication of weights followed by activation) to achieve the transformed embedding of a vertex.

Though the connectivity information is typically available in a compressed format, the format itself does not make the memory access or compute regular. To achieve better locality of data, the adjacency information can be pre-processed to transform the connectivity into a narrow band. The width of this band is called bandwidth. Since the term bandwidth in the context of a sparse matrix overlaps the usage in context of memory data availability, “spread-width” is used herein when the context is a sparse matrix. The formal definition of spread-width of a sparse matrix is given in equation (1):

spread-width=max |i-j|∀aij ≠0 (1)

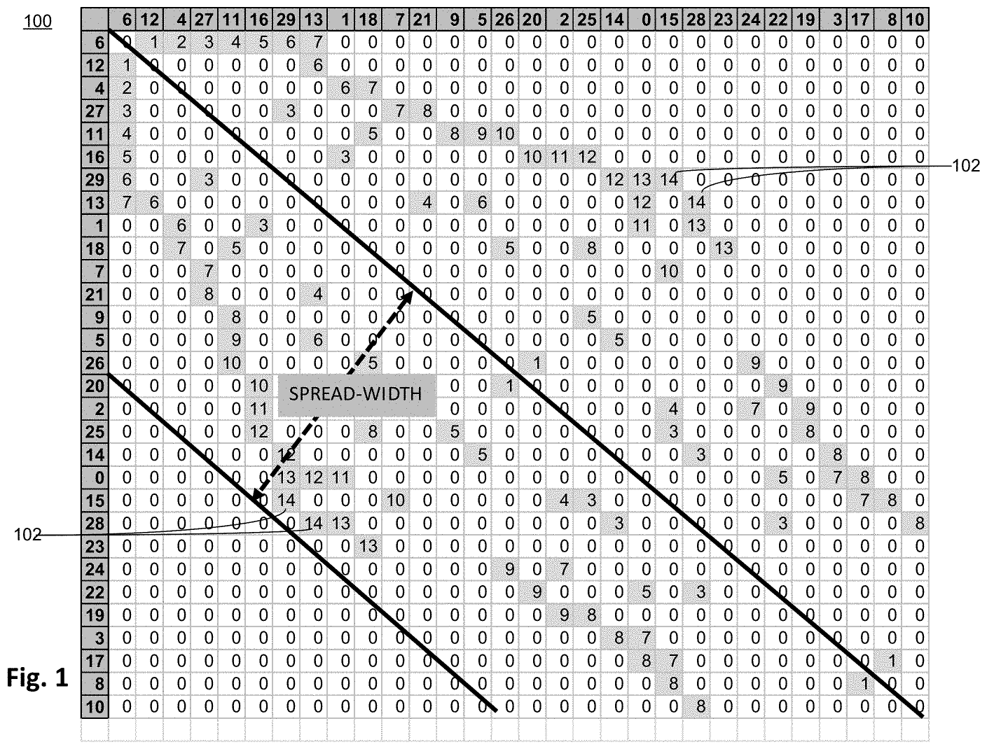

FIG. 1 illustrates an example of the spread-width of an adjacency matrix. Specifically, the spread-width of the adjacency matrix 100 is indicated by the non-zero elements 102 that are furthest from the main diagonal of the adjacency matrix 100 in FIG. 1. An adjacency matrix is a highly sparse matrix that represents the connectivity (edges) between all the nodes in a graph. The adjacency matrix 100 of FIG. 1 represents the connectivity amongst 30 nodes (e.g., nodes 0-29). The adjacency matrix 100 illustrated in FIG. 1 is a representation of a reordered graph. Note that the adjacency matrix 100 is shown with original node ID numbers (not the enumerated node numbers assigned during reordering). Thus, the node numbers are shown as 6, 12, 4, 27, 11, etc. instead of 0, 1, 2, 3, 4, etc.

The non-zero numbers indicate a connection between two nodes and the weight of that connection. For example, node ‘6’ is connected to node ‘12’, and the weight of the connection is ‘1’. In another example, node ‘16’ is connected to node ‘1’, and the weight of the connection is ‘3’. In the illustrated example, the non-zero numbers are max(abs(i-j)) of connected nodes. Note that the example illustrated in FIG. 1 depicts a symmetric matrix (e.g., undirected graph). Typically, for a directed graph, the matrix will not be symmetric, and two spread-width values will be calculated.

In addition to spread-width, “profile” is another parameter used to measure how slim the band of an adjacency matrix is. The profile of an adjacency matrix can be obtained with equations (2) and (3), where i,j are row indices and column indices, respectively, of an adjacency matrix for a graph with “N” nodes, and “fnz” is the first non-zero of the row.

fnz[i]=min{j:aij !=0} (2)

Profile=Σ=1^{N}(i−fnz[i]) (3)

Minimizing spread-width and/or profile improve memory access.

According to examples described herein, there are three primary problems that can contribute to inefficiencies in mapping GNNs to vectorized machines or heterogenous compute (e.g., CPUs/GPUs/HW Accelerators). The three problems include: 1) real life graph datasets can be (a) large with billions of vertices (b) have extremely sparse connectivity, and (c) have a power law distribution for connectivity degree, making graph processing highly challenging with conventional techniques, 2) Memory accesses can be highly irregular (non-contiguous) with indeterministic spatial and temporal locality resulting in multiple data re-fetches and cache thrashing, and 3) The number of operations per vertex can be highly unbalanced resulting in unbalanced compute in vectorized machines.

Consider the first problem mentioned above (real life graph datasets can be (a) large with billions of vertices (b) have extremely sparse connectivity, and (c) have a power law distribution for connectivity degree). Graph datasets can have an irregular structure with 99.99% sparsity in the adjacency matrix representing connectivity information. The following are some examples of the structure of real-world/natural graph datasets. Pinterest® is an application that enables users to save and organize “pins” onto boards. Pins are visual bookmarks to online content (like clothes, shoes, or other online content) and a board is a collection of pins. PinSAGE is a deep learning model that generates embeddings or representations of pins that can be used for recommendation. PinSAGE was developed on Pinterest data and trains on a graph with billions of nodes (e.g., 3 billion nodes and 18 billion edges). Another example, AliGraph, was deployed at Alibaba's® e-Commerce platform for product recommendation and personalized search and has been trained on Alibaba's dataset with millions of nodes (e.g., 490 million nodes and 6.82 billion edges). Thus, real-world graph data sets can be very large, with millions of nodes or more.

Real-world graph data sets can also be highly sparse. For example, a typical graph with V vertices that has an adjacency matrix A of size V×V has very few edges and is a highly sparse (99.99% sparse) matrix. Furthermore, a natural graph dataset can have a power law distribution for the degree of the (destination) vertices. A destination vertex or node is a vertex or node over which a Graph Neural Network layer is to be run. Source vertices or nodes are those that have edges that connect to destination vertices or nodes. The degree of a vertex refers to how many edges are connected to a vertex. The power law distribution of degree implies that there are very few nodes in the dataset with very high degree, while the majority of the vertices have much fewer edges connected to them. Thus, there are typically some “outlier” nodes that have a significantly higher degree than the vast majority of nodes in the graph data set.

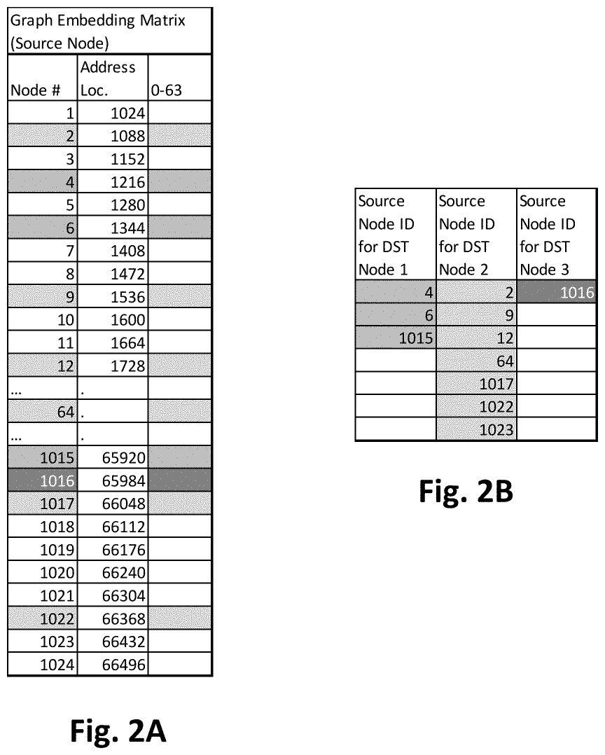

Turning now to the second problem indicated above (e.g., memory accesses can be highly irregular (non-contiguous) with indeterministic spatial and temporal locality), FIG. 2A shows an example of a higher-level memory view (e.g., DRAM, or other memory further away from processing), and FIG. 2B shows an example of an operating set of graphs in low-level local memory.

Aggregation is the stage in GNNs that involves collecting and aggregating embeddings of neighbors of destination nodes. As can be seen in the example of FIG. 2B, different destination nodes may require an irregular number of source nodes from non-contiguous addresses. For example, FIG. 2B illustrates an example in which three source nodes (nodes 4, 6, and 1015) are loaded into local memory for destination node 1. There are seven source nodes (2, 9, 12, 64, 1017, 1022, and 1023) loaded into local memory for destination node 2. There is one source node (node 1016) loaded into local memory for destination node 3. As can be seen in FIG. 2A, the address locations of the source nodes for destination nodes 1-3 are non-contiguous. For example, the addresses for nodes 4, 6, and 1015 are 1216, 1344, and 65920. Due to this, the GNN processing, in particular aggregation, may result in inefficient cache and memory-bandwidth utilization. Profiling results have shown that the aggregation stage can take up the majority of computation time in many GNN algorithms.

Now consider the third problem indicated above (e.g., the number of operations per vertex can be highly unbalanced resulting in unbalanced compute in vectorized machines). During an aggregation operation, the embeddings of neighboring nodes of a vertex are collected and operated upon (e.g., aggregated). The compute per vertex is typically not balanced across the graph because of the varying degrees of the vertices. This makes mapping GNN workloads on heterogenous parallel compute inefficient. The number of source nodes required by different destination nodes can highly irregular (e.g., dataset dependent). Even if the destination nodes were sorted based on their degree (as shown in various plots in FIG. 2), it does not guarantee sharing of source nodes between various destination nodes. Note that the source nodes connected to the same destination node could reside at non-contiguous memory locations. The number of source nodes connected to a destination node represent the amount of aggregations to be computed for that destination node. Hence the irregularity in the node degree distribution may result in unbalanced compute associated with different destination vertices. This makes mapping aggregation to vectorized machines (e.g., CPUs and/or GPUs in servers) unbalanced and inefficient.

Conventional techniques for addressing some of these problems have drawbacks. For example, one technique for addressing the sparsity of graph data is to introduce various sparse compression formats. For example, some GPUs, CPUs, and custom machine learning hardware accelerators (e.g., tensor processing units (TPUs)) try to map GNN computations over their built-in vector multipliers or sparse engines. Typically, they try to utilize various compression formats of sparse matrices. Even though compression formats reduce the volume of data handled, the data itself remains irregular.

In order to make the sparse graphs more regular, the Cuthill McKee algorithm was proposed that permutes a sparse matrix into a band matrix with a smaller spread-width. In “An Algorithm for Reducing the Bandwidth and Profile of a Sparse Matrix” by Gibbs et al., the authors have proposed a method for reducing the spread-width for a sparse matrix with an improvement over the Cuthill McKee algorithm. Gibbs et al., SIAM Journal on Numerical Analysis Vol. 13, No. 2 (April, 1976), pp. 236-250 (15 pages), Published By: Society for Industrial and Applied Mathematics. The authors find a pseudo-diameter of the graph and perform a level structure on the end-points of the pseudo-diameter. In “An Improvement of The Gibbs-Poole-Stockmeyer Algorithm,” the author claims starting nodes on a pseudo-diameter may not necessarily yield good results and proposes an algorithm to find starting nodes of a level structure on the actual diameter of the graph. Gu Feng, Journal of Algorithms & Computational Technology Vol. 4 No. 3., pp. 325-333.

Algorithms like Cuthill McKee and Gibbs-Pool-Stockmeyer may be suitable for smaller graphs but are typically ineffective for large graphs. CPU and GPU caches are designed to leverage temporal or spatial locality of data. Since graph-datasets are by design irregular, conventional processor architectures are inefficient. Large data size coupled with irregularity in access can result in cache thrashing.

Various compression formats exist but have their own drawback. Compression formats such as CSR (compressed sparse row), COO (coordinate format), and CSC (compressed sparse column) typically focus on storage efficiency and not on data movement or compute efficiency. Formats like ELLPACK and TJDS (Transpose Jagged Diagonal Storage) focus on efficient computation. TJDS has poor cache usage. A GPU relies on compute and data accesses being uniform, and typically neither are uniform in graph datasets.

In contrast to conventional techniques, in one example, a low-complexity graph reordering technique (referred to herein as slim-BFS) can improve data locality and reuse of very large graph data. In one example, a method of performing slim-BFS involves performing a breadth first search on a graph data set with the highest degree destination node of the graph data set as a root node (or other node approximating the center of the graph) to generate a reordered graph data set. Candidate nodes are then selected from the last level of the reordered graph. For example, candidate nodes can include one or more of: a first-numbered destination node in the last level, a last-numbered destination node in the last level, and a lowest degree destination node of the last level of the reordered graph data set. BFS is then performed with each of the candidate nodes to generate second reordered graph data sets. The second reordered graph data set with the lowest bandwidth or best profile can be selected for further processing (e.g., with a GNN).

Additionally, a software and hardware-friendly tiling mechanism referred to herein as “Compute-Balanced Tiling (CBT)” can enable better memory utilization and balancing the load on vectorized parallel compute units. In one example, a method of performing compute-balanced tiling includes dividing a graph data set into tiles, wherein each of the tiles includes a subset of destination nodes of the graph data set and source nodes corresponding to each destination node of the subset of destination nodes. In one example, a descriptor for each of the tiles is generated and stored to memory. In one such example, the descriptor for a tile indicates: the number of destination nodes in the subset, destination node IDs to identify each destination node in the subset, the degree of each destination node in the subset, a set of source node IDs to identify the source nodes corresponding to each destination node of the subset. The descriptor can also indicate edge weights for each destination node of the subset for each of the corresponding source nodes.

The graph reordering techniques (e.g., slim-BFS) and tiling techniques (e.g., CBT) described herein can be performed independently, or together. The techniques described herein may have advantages, such as enabling graph handling with high memory efficiency. For example, a data structure, tiling mechanism, and graph reordering technique optimizes memory utilization and data movement and re-use of graph data. Additionally, the techniques described herein may also enable high performance compute. For example, a tiling mechanism can enable balanced compute distribution across parallel compute units. Furthermore, the techniques described herein can enable low complexity pre-processing. For example, a graph tiling operation has a linear order time complexity. This enables pipelining of pre-processing and tile processing steps. Techniques described herein may also enable scalability across platforms. For example, a hardware-friendly data structure can ease the mapping of GNN compute to vectorized machines (e.g., Intel Xeon® AVX instructions/GPU parallel compute/hardware accelerators).

Thus, in accordance with examples described herein, a low-complexity graph reordering technique and a hardware-friendly tiling mechanism can address the problems described herein. For example, a low-complexity graph reordering technique can improve data locality of graph data. In another example, a hardware-friendly tiling mechanism can create “Compute Balanced Graph Tile (CBGT)” for better memory utilization and balancing the load on vectorized parallel compute units.

In one example, a graph reordering technique has low complexity for large graphs and can improve locality and data reuse for efficient memory access and compute. A low complexity graph re-ordering technique is disclosed that can improve locality and hence data reuse of graphs.

Conventional graph reordering typically involves a breadth first search (BFS) performed on all nodes. The BFS resulting in the least spread-width is then selected. However, this can be a computationally expensive approach and is of O(n²) complexity. Other BFS schemes are possible (e.g., Cuthill, Gibbs et al., discussed above) wherein the peripheral nodes of the graph are identified and BFS is performed on the same to obtain the most efficient spread-width of the resulting adjacency matrix. Even these schemes require significant compute, which can be very high for graphs having nodes on the order of billions.

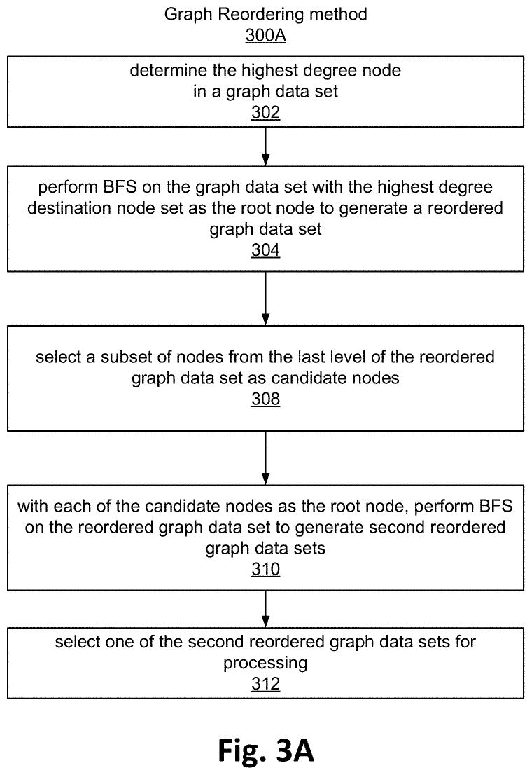

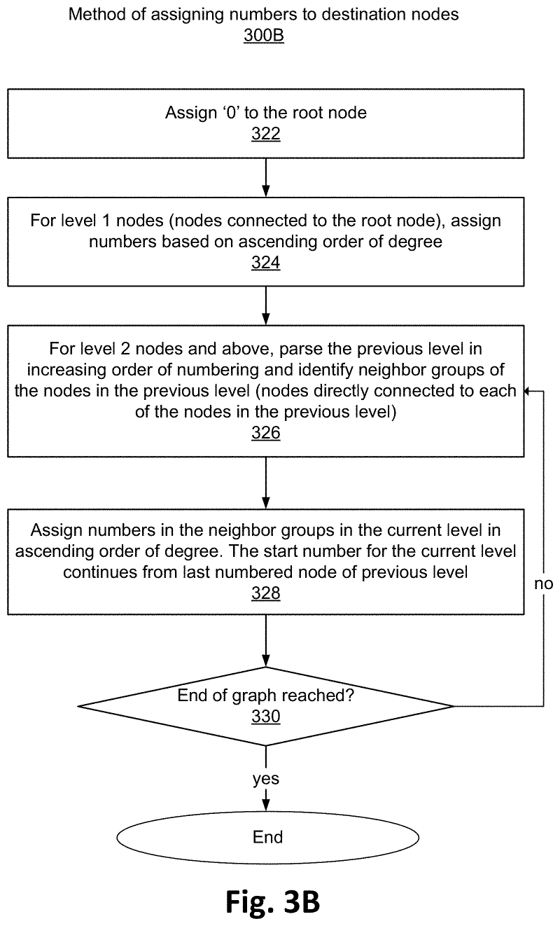

In contrast, an improved reordering technique can result in obtaining a more than 2X improvement in data re-use without the significant compute time required by conventional reordering techniques. FIG. 3A is a flow chart of an example of a method of performing a graph reordering technique. In one example, the method 300A can be implemented in software that is executed by one or more processors.

In one example, the reordering method 300A involves determining which node in a graph data set is the highest degree node, at block 302, and designating that node as the root node. In one such example, the highest degree node is an approximation of the center of the graph data set. Therefore, another node representing the center (e.g., approximate center) of the graph data set can be used. The root node may also be referred to as the starting node. A breadth-first search (BFS) is then performed on the graph data set with the highest degree destination node set as the root node to generate a reordered graph data set, at block 304. In one example, performing the breadth first search includes assigning numbers to destination nodes of the graph data set based on ascending order of degree.

FIG. 3B is a flow chart of an example of a method 300B of assigning numbers to destination nodes (e.g., block 302 of the method 300A of FIG. 3A).

The method 300B of FIG. 3B begins with assigning ‘0’ to the root node (e.g., the highest degree node of the graph data set), at block 322. For level 1 nodes, numbers are assigned based on ascending order of degree, at block 324. Level 1 nodes are nodes directly connected to the root node. In one example, the numbers assigned are contiguous ascending integers. However, other numbering schemes may be used as long as the nodes can be ordered in based on ascending degree.

For level 2 nodes and above, the previous level nodes are parsed or identified in increasing order of numbering, at block 326. The neighbor groups of the nodes in the previous level can then be identified, at block 326. In this example, a neighbor group is a group of nodes in a current level that are directly connected to a node in the previous level. Numbers are then assigned to destination nodes in the neighbor groups in the current level in ascending order of degree, at block 328. According to one example, the start number for the current level continues from the last numbered node of the previous level. If the end of the graph has not been reached, block 330 NO branch, the method continues with identifying and numbering neighbor groups of the nodes in the previous level, at block 326, and assigning numbers in those groups in ascending order of degree, at block 328. Thus, for each current level of the graph data set after the root node, for each node in a previous level in increasing order of numbering, the method involves identifying nodes in the current level with connections to the node in the previous level and assigning numbers to those nodes in the current level in ascending order of degree. In the method 300B, according to one example, ties can be broken arbitrarily and the numbering of nodes in a level are all contiguous. Once the end of the graph is reached, block 330 YES branch, the BFS numbering is complete and the result from the BFS process is a renumbered or reordered graph data set.

Referring again to FIG. 3A, after performing BFS on the graph data set, a subset of node from the last level of the reordered graph data set are selected as candidate nodes, at block 308. In one example, selecting candidate nodes at a periphery of an adjacency matrix of the reordered graph data set. In one example, at least one of the candidate nodes is selected based on its degree or its numbering in the last level. For example, selecting the candidate nodes can include, for example, selecting one or more of: the first-numbered destination node in the last level, the last-numbered destination node in the last level, and the lowest degree destination node of the last level.

After selecting the candidate nodes, with each of the candidate nodes as the root node, the method involves performing BFS on the reordered graph data set to generate second reordered graph data sets, at block 310. For example, if three candidate nodes are selected (e.g., the first-numbered destination node in the last level, the last-numbered destination node in the last level, and the lowest degree destination node of the last level), BFS is performed three times, once with each of the three candidate nodes. Performing BFS on the reordered graph data set with the candidate nodes as the root node generates a second reordered graph data set for each candidate node. The method 300A then involves selecting one of the second reordered graph data sets for processing, at block 312. For example, the method can involve selecting the candidate node with best profile or spread-width for further processing. For example, further processing involves causing the selected graph data set to be processed with a graph neural network.

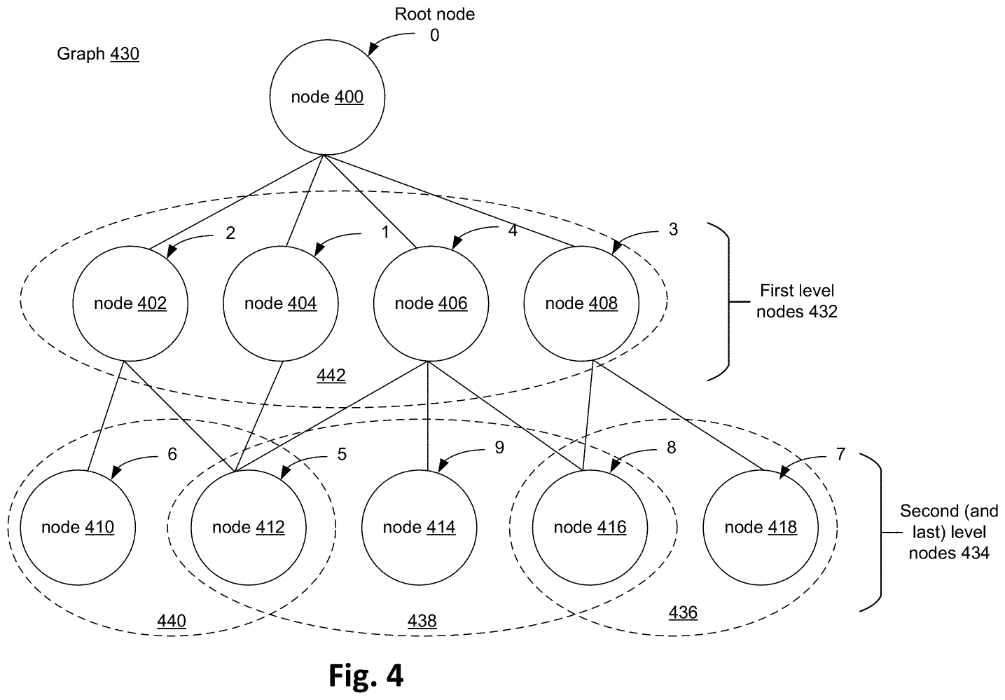

FIG. 4 illustrates an example of a graph with numbers assigned in accordance with the method 300B of FIG. 3B. In the example illustrated in FIG. 4, the graph 430 includes 10 nodes and three levels. The nodes are represented as circles, and lines between the nodes represent connections.

In the example of FIG. 4, to perform BFS numbering, the highest degree node 400 (having a degree of 4) is selected as the root node ‘0’. After assigning ‘0’ to the root node, the first level nodes 432 are numbered. The first level nodes 432 are nodes that are directly connected to the root node, and make up the neighbor group 442 of node 0. The first level nodes 432 are assigned numbers based on ascending order of degree. Therefore, the node 404 with degree 1 is assigned ‘1’, one of the nodes with degree 2 (in this case, node 402) is assigned ‘2’, the other node with degree 2 (in this case, node 408) is assigned ‘3’, and the node 406 with degree 3 is assigned ‘4’. After assigning numbers to the first level nodes, numbers are assigned to the next level (level 2) nodes 434. In this example, the level 2 nodes are also the last level nodes. However, most real-world graphs will have more than two levels.

In one example, numbering the subsequent level groups involves first parsing or identifying the previous level nodes in increasing order of numbering and identifying those nodes neighbor groups. Second level numbering starts from the node that is connected to the lowest numbered node in previous level. Therefore, ‘5’ is assigned to the node connected to lowest numbered node (node 1) in the previous level. For example, the neighbor group of node 1 (404) is node 412. Therefore, ‘5’ is assigned to node 412. Next, the neighbor group 440 of node 2 (402) is identified. Only one unnumbered node 410 is in the neighbor group 440, therefore the number ‘6’ is assigned to node 410. Next, the neighbor group 436 of node 3 (408) is identified. In this example, number ‘8’ is assigned to node 416 and ‘7’ is assigned to node 418 in the ascending order of their degree. Finally, the neighbor group 438 of node 4 (406) is identified, and ‘9’ is assigned to the last remaining node 414. Prior to assigning these numbers, the nodes in the graph 430 may have had a different numbering or ordering, and therefore, the resulting graph is a reordered graph data set.

In one example, after performing BFS renumbering, candidate nodes are selected. In the illustrated example, the first-numbered destination node in the last level is the node numbered ‘5’. The last-numbered node in the last level is the node numbered ‘9’. The lowest degree node is picked from the last level. A tie (e.g., when there are nodes with same lowest degree in the last level) can be broken randomly. For example, in FIG. 4, nodes ‘6’, ‘7’, and ‘9’ all have the same lowest degree of 1. In one such example, one of the nodes having the same lowest degree is randomly selected (e.g., node ‘6’). In one example, if there is a tie for the lowest degree last level node, preference is given to selecting a node that was not selected as another candidate node. For example, if node ‘9’ was already selected as the last numbered last level node, the lowest degree last level node would be selected between nodes ‘6’ and ‘7’. In one example, additional BFS's are then performed with one or more of the candidate nodes set as the root node.

Thus, the methods of FIGS. 3A and 3B can result in a reordered graph data set with a slim spread-width with minimal processing time (e.g., the above methods have a complexity of only O(N)). The highest degree BFS helps in parsing from an approximate center of the graph to the periphery of the graph. Parsing from the selected last level nodes provides approximate diameter end points on the graph. Parsing from the diameter endpoints provide a slim representation in the adjacency matrix and hence a lower spread-width.

In one example, outlier nodes can be removed and processed as an independent graph or kept part of the graph for processing. For example, the method can involve removing outlier nodes from the reordered graph data set prior to performing a breadth first search on the reordered graph data set. Removing outliers prior to performing subsequent BFS numbering with the candidate nodes can result in a narrower spread-width. Following a statistical procedure is one technique for identifying and removing outlier nodes. For example, based on boxplots of degree distribution, the method can involve removing outlier nodes with [minima, maxima] limit set as:

[Q1−1.5e^{-4AMC}IQR, Q3+1.5e^{3AMC}IQR] if AMC >0, and

[Q1−1.5e^{-3AMC}IQR, Q3+1.5e^{4AMC}IQR] if AMC <0

Where AMC is the approximate Medcouple (MC) and indicates the skewness of the degree distribution. In one example, MC is approximate because the degree distribution of the graph is subsampled to reduce MC calculation complexity. Q1 and Q3 are the first and third quartile and IQR is the Inter Quartile Range. After removing the outlier nodes BFS can then be performed on the candidate nodes. Regardless of whether outlier nodes are removed, a significant reduction in spread-width can be achieved. Note that in one example, after reordering, the graph adjacency list is in a reordered form and does not involve any modification/movement of the embedding vectors.

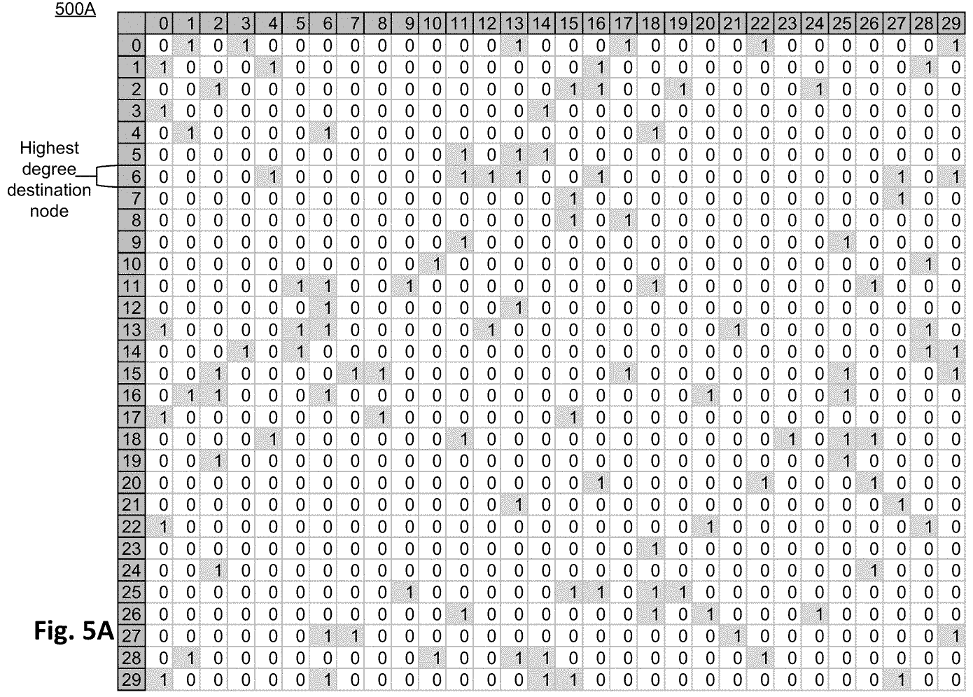

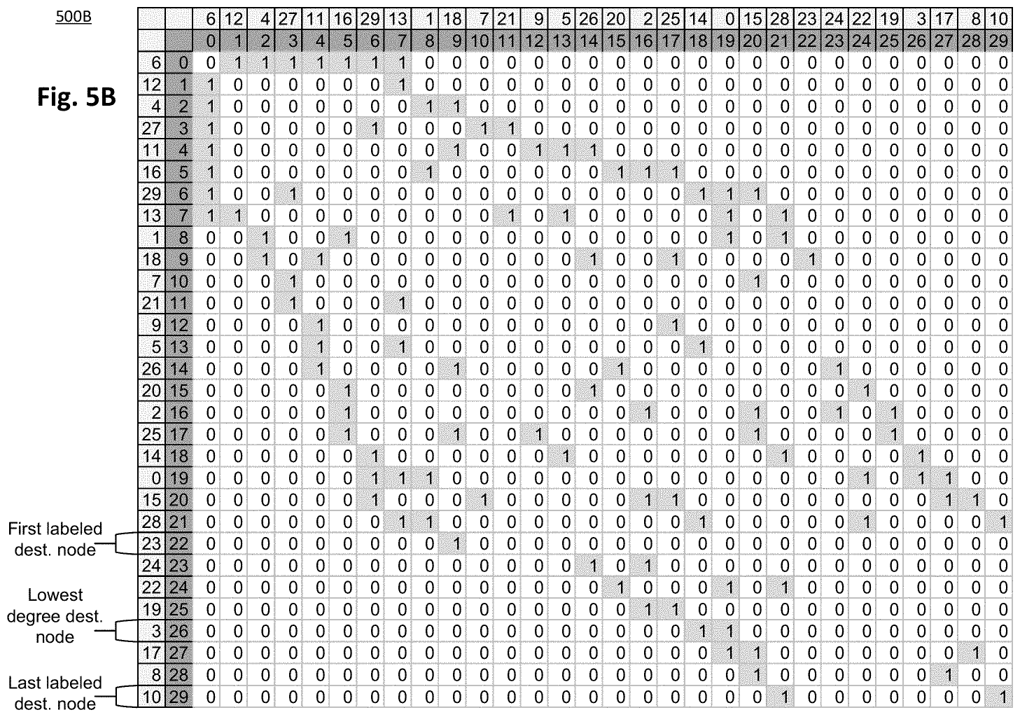

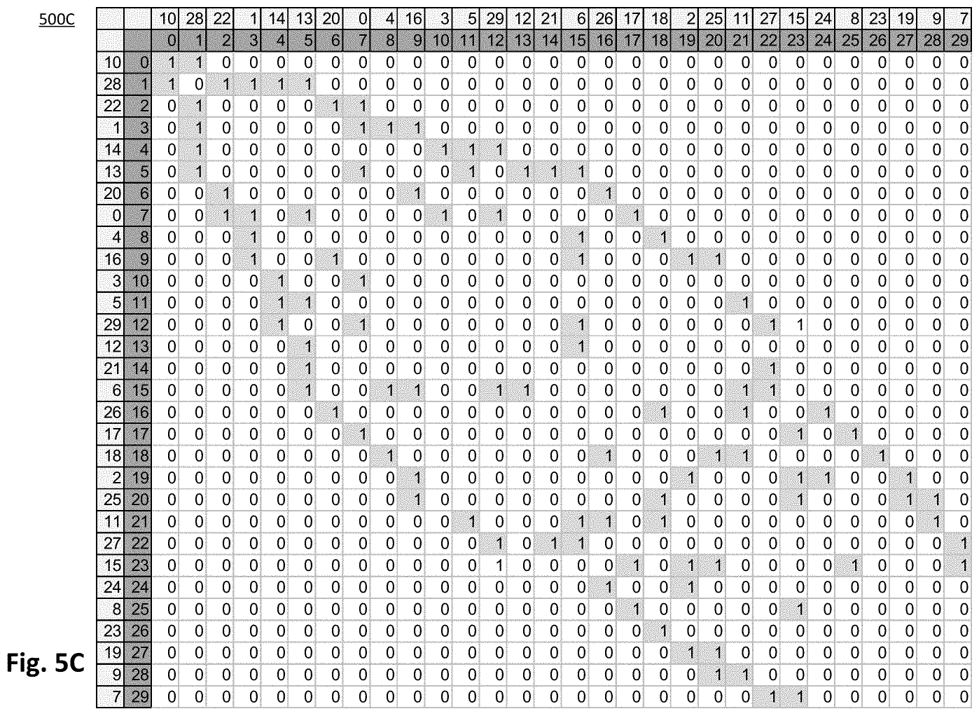

FIGS. 5A-5C illustrate examples of adjacency matrices before and after performing BFS reordering. Note that adjacency matrices shown FIGS. 5A-5C are for representation purpose only. Graph datasets are typically stored as adjacency lists or other available compressed sparse formats. This disclosure considers adjacency lists for connectivity information.

FIG. 5A shows an example of a sample adjacency matrix (an initial adjacency matrix) 500A. The adjacency matrix 500A represents an adjacency matrix of a graph before any BFS reordering. The highest degree destination node of the adjacency matrix 500A is node 6. The bandwidth of the adjacency matrix 500A is 29, and the profile is 314. FIG. 5B shows an example of the reordered version of the matrix of FIG. 5A with a single BFS (e.g., the adjacency matrix after BFS reordering using the highest degree node as the root node). As can be seen in FIG. 5B, the non-zero elements (which represent connections between nodes) of the adjacency matrix 500B are concentrated in a band rather than scattered across the entire matrix. Thus, the bandwidth of the adjacency matrix 500B is lower (bandwidth=14) after the first BFS reordering. The profile of the adjacency matrix 500B after the first BFS reordering is also lower (profile=242). Note that the inner node numbers (0, 1, 2, 3, 4 . . . 29) shown for the adjacency matrix 500B represent the original node IDs, and the outer node numbers (6, 12, 4, 27, 11, 16, etc.) represent the enumerated values assigned during BFS reordering.

After performing BFS reordering on the adjacency matrix with the highest degree node as the root node, candidate nodes for further BFS reordering can be selected. For example, the first labeled destination node of the last level of the adjacency matrix 500B is node 22. The lowest degree destination node of the last level of the adjacency matrix 500B is node 26. The last labeled destination node of the last level of the adjacency matrix 500B is node 29. In one example, BFS is performed with each of these candidate nodes as the root node. Then, according to one example, the resulting adjacency matrix having the narrowest bandwidth or lowest profile is selected.

For example, FIG. 5C shows an example of an adjacency matrix 500C after performing BFS with the minimum bandwidth last level node as the root node. Note that the inner node numbers (0, 1, 2, 3, 4 . . . 29) shown for the adjacency matrix 500C represent the original node IDs, and the outer node numbers (10, 28, 22, 1, 14, 13, etc.) represent the enumerated values assigned during BFS reordering with one of the candidate nodes as the root node. In this example, selecting the last-labeled last level destination node resulted in the lowest bandwidth. The adjacency matrix 500C has a bandwidth of 11 and a profile of 208. Thus, the graph reordering technique described herein can significantly reduce the bandwidth and profile of the adjacency matrix of a graph.

Another technique to improve the processing of large graphs is compute-balanced tiling. As mentioned above, a graph is often represented with an adjacency list. In one example, a large graph can be reordered in accordance with techniques described herein to obtain a graph with a better spread-width. However, even after reordering, a large, reordered graph will still be large.

In one example, a large graph can be “sliced” or tiled based on the amount of compute time expected for each tile. For example, the hardware capability (e.g., lowest level SRAM size) can be used to determine the maximum possible size of the slice. In one example, the sliced unit can ensure (a) optimal memory usage in hardware, (b) optimal data re-use to minimize data transfer between memories, and (c) uniform distribution of compute load across parallel hardware units. A specific format is disclosed in this disclosure referred to as a Compute Balanced Tile (CBGT), which can address memory usage, data re-use, and uniform distribution of compute load across parallel hardware units.

In one example, a method of tiling involves dividing a graph data set into tiles. Each of the tiles includes a sub-set of destination nodes of the graph data set and source nodes corresponding to each destination node of the subset of destination nodes. A descriptor for each tile can be generated and stored in memory. In one example, the descriptor for a tile indicates: the number of destination nodes in the subset, destination node IDs to identify each destination node in the subset, degree of each destination node in the subset, a set of source node IDs to identify the source nodes corresponding to each destination node of the subset, and edge weights for each destination node of the subset for each of the corresponding source nodes. Thus, in one example, each CBT includes a batch of destination nodes and their respective connected source nodes along with any edge weights. The descriptor includes information to identify the subset of destination nodes and other information.

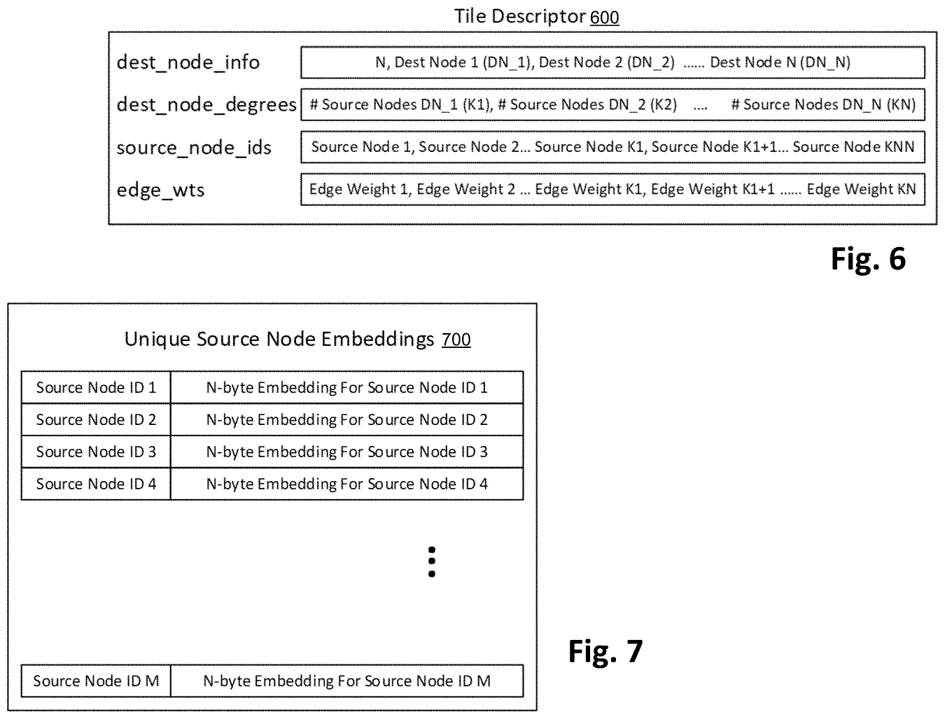

FIG. 6 illustrates an example of a CBT descriptor. As mentioned above, a tile corresponds to a set of destination nodes and the connected source nodes batched together. In the illustrated example, the CBT descriptor 600 includes or indicates the following information: (1) the number of destination nodes (shown as ‘N’ of dest_node_info), (2) destination node IDs of vertices for which the graph processing/GNN result is to be computed (shown as “Dest Node 2 (DN_2) . . . Dest Node N (DN_N)” of dest_node_info), (3) the degrees of the destination nodes (which also correspond to amount of compute per destination node) (shown as dest_node_degrees), (4) a list of source node ID sets, with each set corresponding to a destination node ID (shown as source_node_ids), and (5) edge weights for destination nodes for each source node (shown as edge_wts).

Note that in the example of FIG. 6, even though the CBT descriptor repeats source node IDs across destination IDs, the embedding vectors corresponding to only the unique source node IDs are to be fetched. This is depicted in FIG. 7, which is a table of an example of unique source node embeddings 700 per tile. The information for each tile depicted in FIGS. 6 and 7 can be stored in any suitable data structure or format in memory.

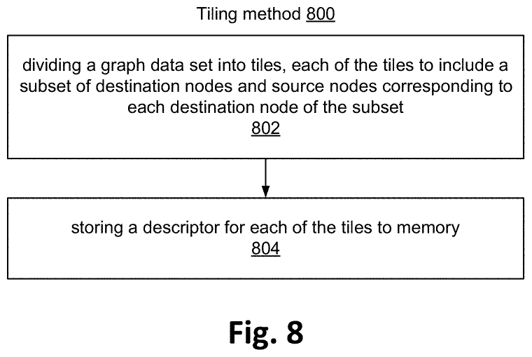

FIG. 8 is a flowchart of an example of a method of tiling. In one example, the method 800 can be implemented in software that is executed by one or more processors. The method 800 can be performed with or without graph reordering.

The method 800 involves dividing a graph data set into tiles, each of the tiles to include a subset of destination nodes and source nodes corresponding to each destination node of the subset, at block 802. In one example, the tiles are organized into tile stripes, where a tile stripe includes tiles having the same subset of destination nodes. The graph data set can be divided such that the compute required or expected for each tile or stripe of tiles is balanced. For example, compute time is balanced if each of the tile stripes is expected to take substantially the same amount of processing. In one example, the processing time is a direct function of the number of edges in the graph (e.g., the number of non-zero elements in the adjacency matrix. Expected compute or processing time can be based on the sum of degrees of the subset of destination nodes in a stripe or tile. In one such example, the graph data set is divided such that the sum of degrees of the subset of destination nodes in a tile stripe is substantially the same for each of the tile stripes.

The method 800 also involves storing a descriptor for each of the tiles to memory, at block 804. In one example, the descriptor is a data structure that indicates the number of destination nodes in the subset, destination node IDs to identify each destination node in the subset, degree of each destination node in the subset, and a set of source node IDs to identify the source nodes corresponding to each destination node of the subset. In one example, the descriptor also indicates edge weights for each destination node of the subset for each of the corresponding source nodes.

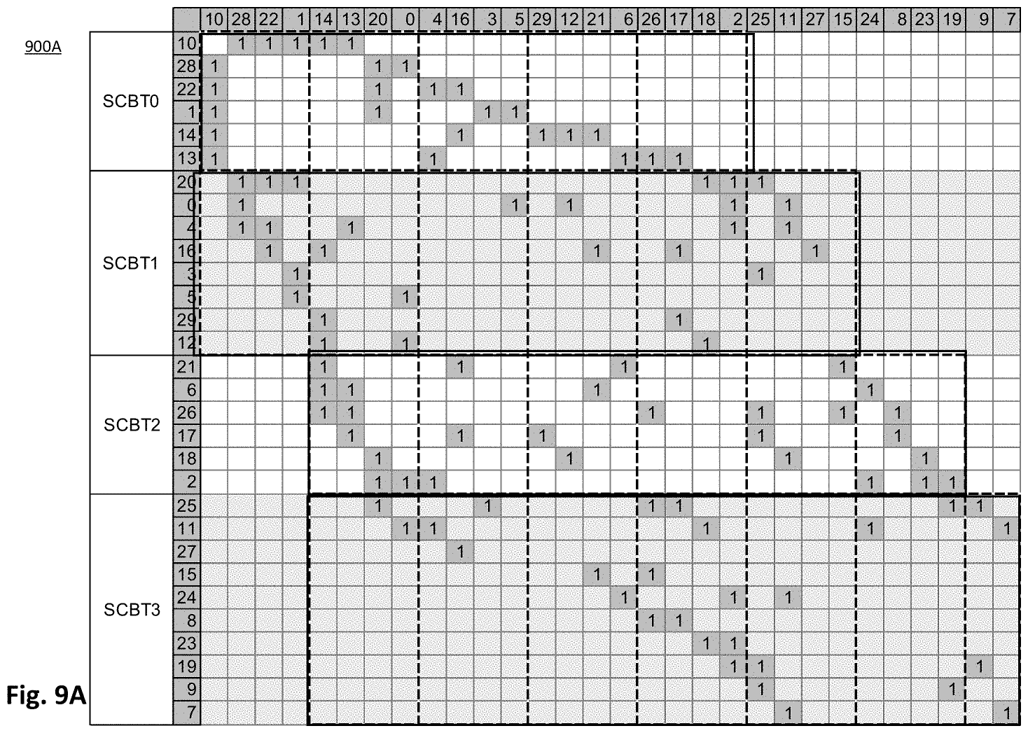

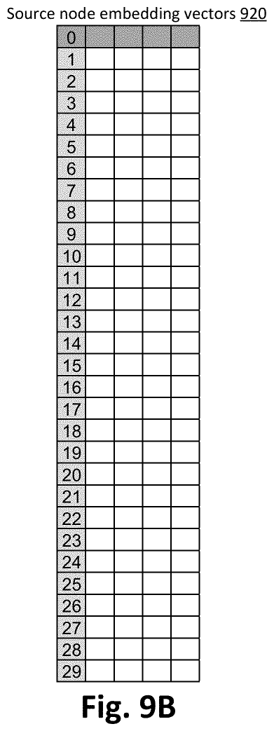

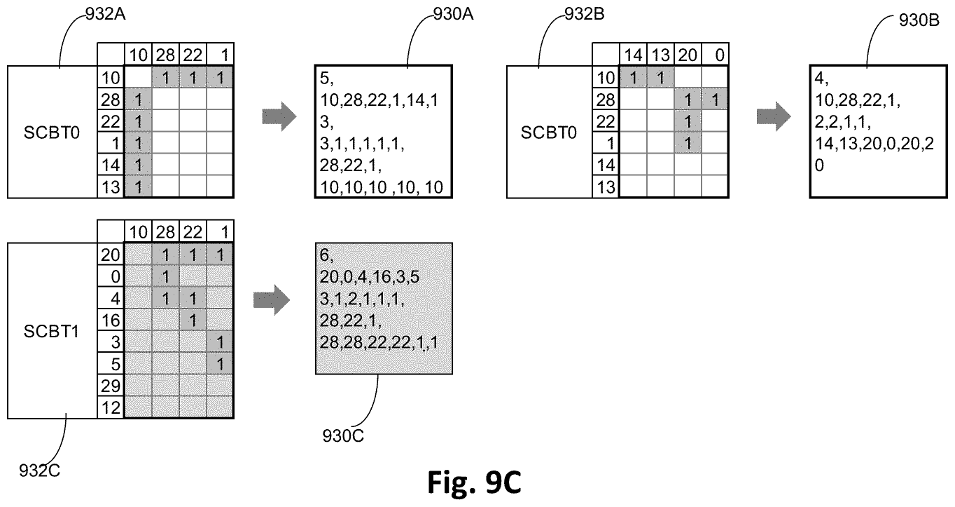

FIGS. 9A-9C show an example of conversion of a reordered graph to CBT tiles. FIG. 9A shows an example of an adjacency matrix of a reordered graph (e.g., reordered in accordance with examples herein). FIG. 9B shows an example of source node embedding vectors 920 per tile. FIG. 9C shows an example of CBT descriptors for three tiles from the adjacency matrix of FIG. 9A.

Referring to FIG. 9A, the adjacency matrix 900A is divided into tiles. In the illustrated example, the matrix 900A is divided into 24 tiles. Note that the reordered adjacency matrix 900A is shown with original node ID numbers (not the enumerated node numbers assigned during reordering). Thus, the node numbers are shown as 10, 28, 22, 1, 14, 13, 20, 0, etc. instead of 0, 1, 2, 3, 4, etc. Boundaries of individual tiles are demarcated with a dashed line. In the illustrated example, the tiles are further grouped or organized into tile stripes, as shown by the tile stripes (SCBT0-SCBT3) in the horizontal direction on the matrix 900A of FIG. 9A. Stripes may also be referred to as groups. In one example, the tiling extent is decided based on hardware capacity. Note that in accordance with one example, after tiling, the graph adjacency list is sliced or tiled and there is no modification or movement of the embedding vectors.

In one example, each tile is a subset of the CBT stripe and the range of source and destination nodes that can be included in a CBT balances the amount of computation per CBT stripe. As mentioned above, in one example, the tile stripes are balanced so that they take substantially the same amount of processing time. Referring to FIG. 9A, SCBT0 has 26 edges and SCBT1 has 30 edges, SCBT2 has 29 edges, and SCBT3 has 28 edges. Therefore, the tile stripes will take a similar amount of time to compute. In one example, the number of destination nodes assigned to a CBT does not exceed the memory capacity the hardware can allocate. According to one example, the number of source nodes is maximized to fill the input memory. The tiling is done once for the dataset and most optimal tile walk pattern (choosing order of tiles to pick for compute) can be chosen based on number of parallel compute-cluster units.

Referring now to FIG. 9C, each of the tiles can be represented by a descriptor as discussed above. Three CBT descriptors are shown in FIG. 9C, including two CBT descriptors 930A and 930B from tile stripe SCBT0 and one CBT descriptor 930C from tile stripe SCBT1. The CBT descriptors 930A and 930B represent the tiles 932A and 932B, respectively. The CBT descriptor 930C represents the tile 932C. As can be seen in the example of FIG. 9C, the CBT descriptor 930A indicates that there are 5 destination nodes and indicates that the destination node IDs are 10, 28, 22, 1, 14, and 13. The descriptor 930A further indicates the weights of the subset of destination nodes (3, 1, 1, 1, 1, 1), and the corresponding source node IDs (source nodes 28, 22, and 1 for destination node 10, and source node 10 for each of destination nodes 28, 22, 1, 14, and 15. Thus, the descriptors can be accessed by processors to identify the relevant information for performing operations on the tiles.

Tiling a large matrix into CBTs can provide the following benefits: (1) dense packing of sparse data that enable high density compute, (2) configurable tile structure which is scale-able for very large graphs as well, (3) the destination node ID being part of CBT ensures that large graphs are not subject to embedding data shuffling and all operations are done based on indexed data. The descriptor only contains a list of destination and corresponding source node ID's that are part of the tile. Embedding data continues to reside at the original memory location, and (4) flexible walk-pattern of tiles for varying hardware configuration.

Thus, graph reordering, tiling, or both can be used to improve processing of large graphs. One type of processing performed on large graphs is inferencing. In one example, inferencing typically involves processing data (such as graphs) with a neural network to provide a prediction or other output from the input data. Inference can be performed on a full graph; however, inference can also be performed on a small sub-graph (subset of nodes). For example, consider an example in which a large graph includes nodes for all cities in a region. Such a graph can be processed in its entirety, but it may also be useful to process only the nodes corresponding to one of the cities.

In one example, inference on the full graph uses re-ordered nodes based on slim-BFS reordering. In one such example, the workload is organized into CBT tiles, and a suitable walk pattern is chosen. The compiled walk is executed on the target hardware.

In another example, inference on a small sub-graph need not run slim-BFS on the sub-graph again, rather, the nodes are sorted based on the tile stripe IDs assigned to these nodes during slim-BFS reordering or tiling. This tile stripe ID-based sorting can achieve nearly the same data re-use as slim-BFS based-reordering, and it further reduces the sub-graph traversal complexity by a factor of tile-size. Sorted sub graph nodes can be further tiled according to CBT techniques described herein. Thus, in addition to reordering and/or tiling a large graph, in some examples, a subset of compute-balanced tiles are further reordered based on tile stripe ID. The subset of compute-balanced tiles reordered based on tile stripe ID can then be tiled a second time.

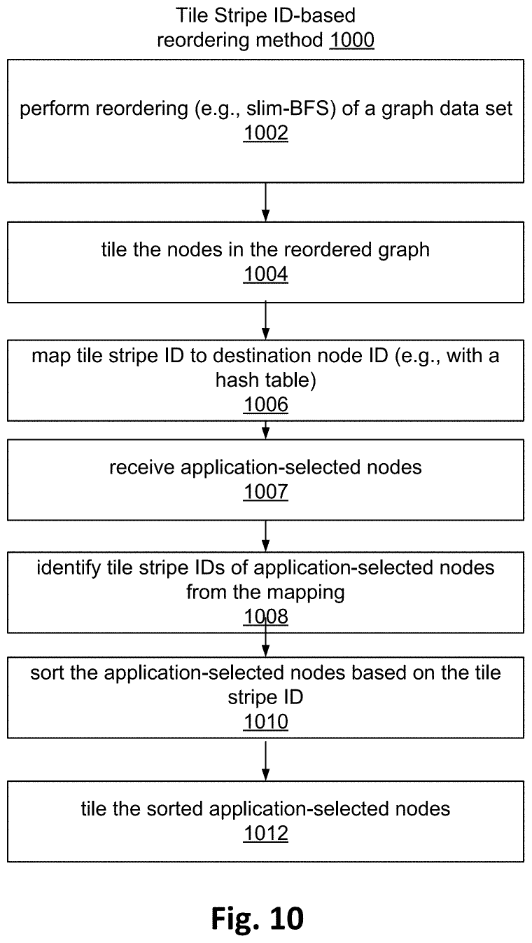

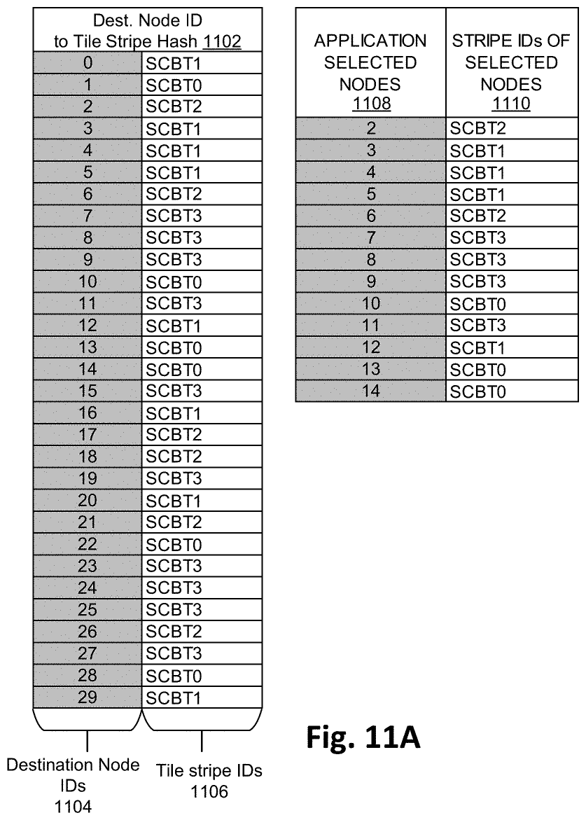

FIG. 10 is a flow chart of an example of a method 1000 of tile stripe ID-based reordering. In one example, the method 1000 can be implemented in software that is executed by one or more processors.

In one example, the method 1000 begins with reordering a graph data set, at block 1002. In one such example, the graph data set may be reordered in accordance with the techniques described herein (e.g., slim-BFS). In other examples, the graph data set may not be reordered prior to tiling. The method then involves tiling the nodes in the reordered graph, at block 1004. Tiling can be performed in accordance with techniques described herein (e.g., dividing the graph data set into compute-balanced tiles). A tile stripe ID is provided to the tile stripes thus created and stored as meta-data during the reordering or tiling process.

After tiling the graph data set, the method 1000 involves mapping the tile stripe ID of the stripe to the corresponding destination node IDs, at block 1006. Any mapping technique or structure to enable identifying tile stripe IDs from the destination node ID may be used. For example, a hash table, a hash map, a look-up table, a search tree, or other mapping structure can be used. For example, referring to FIG. 9C, mapping tile stripe ID to destination node ID would involve mapping the tile stripe ID for stripe SCBT0 to destination nodes 10, 28, 22, 1, 14, and 13.

Referring again to FIG. 10, the method 1000 involves receiving a selection of nodes (“application-selected nodes”) from an application, at block 1007. In one example, the application-selected nodes include a subset of the destination nodes of the graph data set to be processed. The tile stripe IDs can then be determined for the application-selected nodes, at block 1008. For example, the tile stripe IDs can be identified from a tile stripe ID hash table (or other mapping structure) by providing the selected destination node IDs.

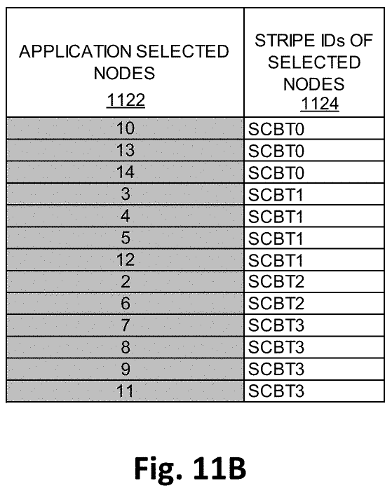

The application-selected nodes are then sorted based on the tile stripe ID, at block 1010. Sorting according to tile stripe ID can involve, for each application selected node, fetching the corresponding CBT stripe ID assigned in the previous reordering and sorting or reordering the application selection nodes based on the CBT Stripe ID. A subset of the graph data set including the application-selected nodes can then be tiled a second time to generate second tiles, at block 1012. In one such example, the second tiles are also selected to balance expected processing time, as discussed above. FIGS. 11A and 11B illustrate an example of application-selected nodes before and after reordering based on tile stripe ID. FIG. 11A illustrates a hash table 1102 or other mapping of destination node IDs (numbers) 1104 to tile stripe ID 1106. The application selected nodes 1108 are a subset of the destination nodes 1104, and the tile stripe IDs 1110 are the stripe IDs corresponding to the application-selected nodes 1108. The application selected nodes are then sorted or reordered based on the corresponding tile stripe IDs. For example, FIG. 11B shows the application selected nodes 1122 reordered based on the corresponding tile stripe IDs 1124. In the illustrated example, the application-selected nodes or sorted according to ascending tile stripe IDs (e.g., SCBT0, SCBT1, SCBT2, then SCBT3).

Results obtained indicate a significant aggregation time reduction due to BFS based re-ordering. Further, pre-processing time can be reduced because of Tile stripe ID-based reordering. In addition to a reduction in aggregation time, data-set analysis shows that a uniform compute density can be achieved by appropriate clustering of connected source and destination nodes. This clustering can be achieved through the CBT tiling process described herein.

In addition to a reduction in aggregation time and uniform compute density, increased data re-use/locality due to slim-BFS can be achieved with techniques described herein. In one example, as a result of slim-BFS, the number of unique source nodes required per tile drops significantly. The number of unique source nodes per tile on average is significantly less than what is it would be without a BFS based reordering.

Furthermore, data reuse across tiles can be increased. For data transfers on any hardware, it is typically desirable that there be data overlap between two adjacent tiles being operated on. With slim-BFS reordering techniques described herein, common nodes between overlapping tiles can be significantly increased. Note that although specific examples herein refer to reordering and tiling of graphs, the techniques described herein can be used to reorder and/or tile a matrix for any sparse matrix operations. For example, the techniques described herein can be used in applications such as matrix multiplication where one matrix is very sparse matrix and the other is a dense matrix (dense matrix-sparse matrix multiplication), or for other applications using sparse matrices.

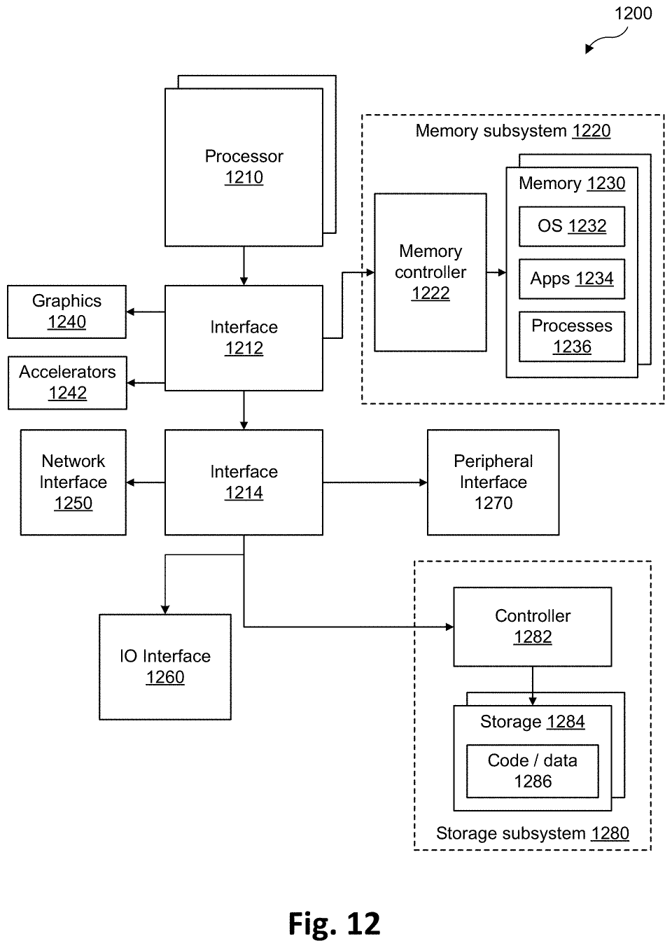

FIG. 12 depicts a compute platform 1200 such as a server or similar computing system in which techniques described herein may be implemented. Compute platform 1200 includes one or more processors 1210, which provides processing, operation management, and execution of instructions for compute platform 1200. Processor 1210 can include any type of microprocessor, central processing unit (CPU), graphics processing unit (GPU), processing core, multi-core processor or other processing hardware to provide processing for compute platform 1200, or a combination of processors. Processor 1210 controls the overall operation of compute platform 1200, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In some examples, processing may be split between a CPU and a GPU. For example, it is common to implement TensorFlow on compute platforms including a CPU and a GPU. In some examples, the CPU and GPU are separate components. In other embodiments, a CPU and GPU may be implemented in a System on a Chip (SoC) or in a multi-chip module or the like.

In one example, compute platform 1200 includes interface 1212 coupled to processor 1210, which can represent a higher speed interface or a high throughput interface for system components that needs higher bandwidth connections, such as memory subsystem 1220 or optional graphics interface components 1240, or optional accelerators 1242. Interface 1212 represents an interface circuit, which can be a standalone component or integrated onto a processor die. Where present, graphics interface 1240 interfaces to graphics components for providing a visual display to a user of compute platform 1200. In one example, graphics interface 1240 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 1240 generates a display based on data stored in memory 1230 or based on operations executed by processor 1210 or both. In one example, graphics interface 1240 generates a display based on data stored in memory 1230 or based on operations executed by processor 1210 or both.

In some examples, accelerators 1242 can be a fixed function offload engine that can be accessed or used by a processor 1210. For example, an accelerator among accelerators 1242 can provide data compression capability, cryptography services such as public key encryption (PKE), cipher, hash/authentication capabilities, decryption, or other capabilities or services. In some examples, in addition or alternatively, an accelerator among accelerators 1242 provides field select controller capabilities as described herein. In some cases, accelerators 1242 can be integrated into a CPU socket (e.g., a connector to a motherboard or circuit board that includes a CPU and provides an electrical interface with the CPU). For example, accelerators 1242 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 1242 can provide multiple neural networks, CPUs, processor cores, general purpose graphics processing units, or graphics processing units can be made available for use by AI or ML models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, graph neural network, or other AI or ML model. Multiple neural networks, processor cores, or graphics processing units can be made available for use by AI or ML models.

Memory subsystem 1220 represents the main memory of compute platform 1200 and provides storage for code to be executed by processor 1210, or data values to be used in executing a routine. Memory subsystem 1220 can include one or more memory devices 1230 such as read-only memory (ROM), flash memory, one or more varieties of random access memory (RAM) such as DRAM, or other memory devices, or a combination of such devices. Memory 1230 stores and hosts, among other things, operating system (OS) 1232 to provide a software platform for execution of instructions in compute platform 1200. Additionally, applications 1234 can execute on the software platform of OS 1232 from memory 1230. Applications 1234 represent programs that have their own operational logic to perform execution of one or more functions. Processes 1236 represent agents or routines that provide auxiliary functions to OS 1232 or one or more applications 1234 or a combination. OS 1232, applications 1234, and processes 1236 provide software logic to provide functions for compute platform 1200. In one example, memory subsystem 1220 includes memory controller 1222, which is a memory controller to generate and issue commands to memory 1230. It will be understood that memory controller 1222 could be a physical part of processor 1210 or a physical part of interface 1212. For example, memory controller 1222 can be an integrated memory controller, integrated onto a circuit with processor 1210.

While not specifically illustrated, it will be understood that compute platform 1200 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, compute platform 1200 includes interface 1214, which can be coupled to interface 1212. In one example, interface 1214 represents an interface circuit, which can include standalone components and integrated circuitry. In one example, multiple user interface components or peripheral components, or both, couple to interface 1214. Network interface 1250 provides compute platform 1200 the ability to communicate with remote devices (e.g., servers or other computing devices) over one or more networks. Network interface 1250 can include an Ethernet adapter, wireless interconnection components, cellular network interconnection components, USB (universal serial bus), or other wired or wireless standards-based or proprietary interfaces. Network interface 1250 can transmit data to a device that is in the same data center or rack or a remote device, which can include sending data stored in memory. Network interface 1250 can receive data from a remote device, which can include storing received data into memory. Various embodiments can be used in connection with network interface 1250, processor 1210, and memory subsystem 1220.

In one example, compute platform 1200 includes one or more IO interface(s) 1260. IO interface 1260 can include one or more interface components through which a user interacts with compute platform 1200 (e.g., audio, alphanumeric, tactile/touch, or other interfacing). Peripheral interface 1270 can include any hardware interface not specifically mentioned above. Peripherals refer generally to devices that connect dependently to compute platform 1200. A dependent connection is one where compute platform 1200 provides the software platform or hardware platform or both on which operation executes, and with which a user interacts.

In one example, compute platform 1200 includes storage subsystem 1280 to store data in a nonvolatile manner. In one example, in certain system implementations, at least certain components of storage 1280 can overlap with components of memory subsystem 1220. Storage subsystem 1280 includes storage device(s) 1284, which can be or include any conventional medium for storing large amounts of data in a nonvolatile manner, such as one or more magnetic, solid state, or optical based disks, or a combination. Storage 1284 holds code or instructions and data 1286 in a persistent state (i.e., the value is retained despite interruption of power to compute platform 1200). Storage 1284 can be generically considered to be a “memory,” although memory 1230 is typically the executing or operating memory to provide instructions to processor 1210. Whereas storage 1284 is nonvolatile, memory 1230 can include volatile memory (i.e., the value or state of the data is indeterminate if power is interrupted to compute platform 1200). In one example, storage subsystem 1280 includes controller 1282 to interface with storage 1284. In one example, controller 1282 is a physical part of interface 1214 or processor 1210 or can include circuits or logic in both processor 1210 and interface 1214.

Volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). A memory subsystem as described herein can be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/Output version 2, JESD229-2 originally published by JEDEC in August 2014, HBM (High Bandwidth Memory, JESD325, originally published by JEDEC in October 2013, DDR5 (DDR version 5), LPDDR5, HBM2E, HBM3, and HBM-PIM, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In an example, compute platform 1200 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), quick UDP Internet Connections (QUIC), RDMA over Converged Ethernet (RoCE), Peripheral Component Interconnect express (PCIe), Intel® QuickPath Interconnect (QPI), Intel® Ultra Path Interconnect (UPI), Intel® On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof. Data can be copied or stored to virtualized storage nodes using a protocol such as NVMe over Fabrics (NVMe-oF) or NVMe.

In addition to systems with CPUs, the teaching and principles disclosed herein may be applied to Other Processing Units (collectively termed XPUs) including one or more of Graphic Processor Units (GPUs) or General Purpose GPUs (GP-GPUs), Tensor Processing Units (TPUs), Data Processor Units (DPUs), Infrastructure Processing Units (IPUs), Artificial Intelligence (AI) processors or AI inference units and/or other accelerators, FPGAs and/or other programmable logic (used for compute purposes), etc. While some of the diagrams herein show the use of CPUs, this is merely exemplary and non-limiting. Generally, any type of XPU may be used in place of a CPU in the illustrated embodiments. Moreover, as used in the following claims, the term “processor” is used to generically cover CPUs and various forms of XPUs.

As will be recognized by those skilled in the art, data pre-processing such as graph reordering and tiling, may employ a single machine (compute platform, server, compute node, etc.) or may employ distributed set of machines. Accordingly, a system used to implement the techniques described and illustrated herein may include compute resources (e.g., a processor, memory, etc.) for a single compute platform/server/node or a set of interconnected compute platforms, servers, or nodes. Moreover, processes may be distributed over a set of compute resources in a single machine, such as distributed across CPU cores in a multi-core processor, distributed between a CPU and a GPU, distributed among multiple GPUs, or more generally distributed across multiple processors comprising CPUs and XPUs.

Examples of graph reordering and tiling techniques follow.

Example 1: A method including: performing a breadth first search on a graph data set with a highest degree destination node of the graph data set as a root node to generate a reordered graph data set, the reordered graph set including multiple levels, selecting a subset of nodes from the last level of the reordered graph data set as candidate nodes, with each of the candidate nodes as the root node, performing a breadth first search on the reordered graph data set to generate second reordered graph data sets, and selecting one of the second reordered graph data sets for processing.

Example 2: The method of example 1, wherein performing the breadth first search includes assigning numbers to nodes of the graph data set based on ascending order of degree.

Example 3: The method of any of examples 1-3, wherein assigning numbers to the nodes based on ascending order of degree includes, for each current level of the graph data set after the root node: for each node in a previous level in increasing order of numbering: identifying nodes in the current level with connections to the node in the previous level, and assigning numbers to the nodes in the current level with connections to the node in the previous level in ascending order of degree.

Example 4: The method of any of examples 1-3, wherein selecting the candidate nodes from the last level of the reordered graph data set involves selecting nodes at a periphery of a graph of the reordered graph data set.

Example 5: The method of any of examples 1-4, wherein selecting the candidate nodes from the last level of the reordered graph data set involves selecting at least one of the candidate nodes in the last level based on degree.

Example 6: The method of any of examples 1-5, wherein selecting the candidate nodes from the last level of the reordered graph data set involves selecting a first-numbered destination node in the last level as one of the candidate nodes.

Example 7: The method of any of examples 1-6 wherein selecting the candidate nodes from the last level of the reordered graph data set involves selecting a last-numbered destination node in the last level as one of the candidate nodes.

Example 8: The method of any of examples 1-7, wherein selecting the candidate nodes from the last level of the reordered graph data set involves selecting: a first-numbered destination node in the last level, a last-numbered destination node in the last level, and a lowest degree destination node of the last level.

Example 9: The method of any of examples 1-8, wherein selecting one of the second reordered graph data sets for processing involves selecting a second reordered graph data set having an adjacency matrix with the lowest spread-width.

Example 10: The method of any of examples 1-9, further including removing outlier nodes from the reordered graph data set prior to performing a breadth first search on the reordered graph data set.

Example 11: The method of any of examples 1-10, further including causing the selected one of the second reordered graph data sets to be processed with a graph neural network.

Example 12: The method of any of examples 1-11, further including dividing the reordered graph data set into tiles, wherein each of the tiles includes a sub-set of destination nodes of the reordered graph data set and one or more source nodes corresponding to each of the sub-set of destination nodes.

Example 13: The method of any of examples 1-12, further including organizing the tiles into tile stripes, wherein a tile stripe includes tiles having the same subset of destination nodes, and causing each of the tile stripes to be processed concurrently with a graph neural network.

Example 14: A method including: dividing a graph data set into tiles, each of the tiles to include a subset of destination nodes of the graph data set and one or more source nodes corresponding to each destination node of the subset of destination nodes; and storing a descriptor for each of the tiles to memory, the descriptor for a tile to indicate: a number of destination nodes in the subset, destination node IDs to identify each destination node in the subset, degree of each destination node in the subset, and a set of source node IDs to identify the one or more source nodes corresponding to each destination node of the subset.

Example 15: The method of example 14, wherein: the descriptor for a tile is to further indicate: edge weights for each destination node of the subset for each of the corresponding source nodes.

Example 16: The method of any of examples 14-15, wherein: the tiles are organized into tile stripes, wherein a tile stripe includes tiles having the same subset of destination nodes.

Example 17: The method of any of examples 14-16, wherein dividing the graph data set into tiles involves dividing the graph data set to balance compute for each of the tile stripes, wherein each of the tile stripes is expected to take a substantially same amount of processing.

Example 18: The method of any of examples 14-17, further including hashing tile stripe IDs for the tiles to generate a tile stripe ID hash map for each node of the graph data set.

Example 19: The method of any of examples 14-18 wherein: a sum of degrees of the subset of destination nodes in a tile stripe is substantially the same for each of the tile stripes.

Example 20: The method of any of examples 14-19, further including: receiving application-selected nodes, wherein the application-selected nodes include a subset of destination nodes of the graph data set to be processed.

Example 21: The method of any of examples 14-20, further including: identifying tile stripe IDs of the application-selected nodes, and sorting the application-selected nodes based on the tile stripe ID of the application-selected nodes.

Example 22: The method of any of examples 14-21, further including: hashing tile stripe IDs for the tiles to generate a tile stripe ID hash map for each node of the graph data set, and identifying the tile stripe IDs from the tile stripe ID hash map.

Example 23: The method of any of examples 14-22, further including dividing a subset of the graph data set including the sorted application-selected nodes into second tiles.

Example 24: The method of any of examples 1-23, further including causing each of the second tiles to be processed in parallel.

Example 25: The method of any of examples 14-24, further including prior to dividing a graph data set into tiles, reordering the graph data set, including: performing a breadth first search on the graph data set with a highest degree destination node of the graph data set as a root node to generate a reordered graph data set, the reordered graph set including multiple levels, selecting a subset of nodes from the last level of the reordered graph data set as candidate nodes, with each of the candidate nodes as the root node, performing a breadth first search on the reordered graph data set to generate second reordered graph data sets, and selecting one of the second reordered graph data sets for processing.

Example 26: A non-transitory machine-readable medium having instructions stored thereon configured to be executed on one or more processors to perform a method in accordance with any of examples 1-25.

Example 27: A computing system including: one or more processors and memory coupled to the one or more processors, the memory having instructions stored therein configured to be executed on at least one of the one or more processors to enable the system to perform a method in accordance with any of examples 1-25.

Flow diagrams as illustrated herein provide examples of sequences of various process actions. The flow diagrams can indicate operations to be executed by a software or firmware routine, as well as physical operations. A flow diagram can illustrate an example of the implementation of states of a finite state machine (FSM), which can be implemented in hardware and/or software. Although shown in a particular sequence or order, unless otherwise specified, the order of the actions can be modified. Thus, the illustrated diagrams should be understood only as examples, and the process can be performed in a different order, and some actions can be performed in parallel. Additionally, one or more actions can be omitted; thus, not all implementations will perform all actions.

To the extent various operations or functions are described herein, they can be described or defined as software code, instructions, configuration, and/or data. The content can be directly executable (“object” or “executable” form), source code, or difference code (“delta” or “patch” code). The software content of what is described herein can be provided via an article of manufacture with the content stored thereon, or via a method of operating a communication interface to send data via the communication interface. A machine readable storage medium can cause a machine to perform the functions or operations described and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to what is disclosed and implementations of the invention without departing from their scope. Therefore, the illustrations and examples herein should be construed in an illustrative, and not a restrictive sense. The scope of the invention should be measured solely by reference to the claims that follow.

What is claimed is:

1. A non-transitory machine-readable medium having instructions stored thereon configured to be executed on one or more processors to perform a method comprising:
performing a breadth first search on a graph data set with a node representing a center of the graph data set as a root node to generate a reordered graph data set, the reordered graph set including multiple levels;
selecting a subset of nodes from the last level of the reordered graph data set as candidate nodes;
with each of the candidate nodes as the root node, performing a breadth first search on the reordered graph data set to generate second reordered graph data sets; and
selecting one of the second reordered graph data sets for processing.

2. The non-transitory machine-readable medium of claim 1, wherein performing the breadth first search includes:
assigning numbers to nodes of the graph data set based on ascending order of degree.

3. The non-transitory machine-readable medium of claim 2, wherein assigning numbers to the nodes based on ascending order of degree comprises:
for each current level of the graph data set after the root node:
for each node in a previous level in increasing order of numbering:
identifying nodes in the current level with connections to the node in the previous level, and
assigning numbers to the nodes in the current level with connections to the node in the previous level in ascending order of degree.

4. The non-transitory machine-readable medium of claim 1, wherein selecting the candidate nodes from the last level of the reordered graph data set comprises:
selecting nodes at a periphery of a graph of the reordered graph data set.

5. The non-transitory machine-readable medium of claim 1, wherein selecting the candidate nodes from the last level of the reordered graph data set comprises:
selecting at least one of the candidate nodes in the last level based on degree.

6. The non-transitory machine-readable medium of claim 1, wherein selecting the candidate nodes from the last level of the reordered graph data set comprises:
selecting a first-numbered destination node in the last level as one of the candidate nodes.

7. The non-transitory machine-readable medium of claim 1, wherein selecting the candidate nodes from the last level of the reordered graph data set comprises:
selecting a last-numbered destination node in the last level as one of the candidate nodes.

8. The non-transitory machine-readable medium of claim 1, wherein selecting the candidate nodes from the last level of the reordered graph data set comprises:
selecting: a first-numbered destination node in the last level, a last-numbered destination node in the last level, and a lowest degree destination node of the last level.

9. The non-transitory machine-readable medium of claim 1, wherein selecting one of the second reordered graph data sets for processing comprises:
selecting a second reordered graph data set having an adjacency matrix with the lowest spread-width.

10. The non-transitory machine-readable medium of claim 1, further comprising:
removing outlier nodes from the reordered graph data set prior to performing a breadth first search on the reordered graph data set.

11. The non-transitory machine-readable medium of claim 1, further comprising:
causing the selected one of the second reordered graph data sets to be processed with a graph neural network.

12. The non-transitory machine-readable medium of claim 1, further comprising:
dividing the reordered graph data set into tiles, wherein each of the tiles includes a sub-set of destination nodes of the reordered graph data set and one or more source nodes corresponding to each of the sub-set of destination nodes.

13. The non-transitory machine-readable medium of claim 12, further comprising:
organizing the tiles into tile stripes, wherein a tile stripe includes tiles having the same subset of destination nodes; and
causing each of the tile stripes to be processed concurrently with a graph neural network.

14. A non-transitory machine-readable medium having instructions stored thereon configured to be executed on one or more processors to perform a method comprising:
dividing a graph data set into tiles, each of the tiles to include a subset of destination nodes of the graph data set and one or more source nodes corresponding to each destination node of the subset of destination nodes; and
storing a descriptor for each of the tiles to memory, the descriptor for a tile to indicate:
a number of destination nodes in the subset,
destination node IDs to identify each destination node in the subset,
degree of each destination node in the subset, and
a set of source node IDs to identify the one or more source nodes corresponding to each destination node of the subset.

15. The non-transitory machine-readable medium of claim 14, wherein:
the descriptor for a tile is to further indicate: edge weights for each destination node of the subset for each of the corresponding source nodes.

16. The non-transitory machine-readable medium of claim 14, wherein:
the tiles are organized into tile stripes, wherein a tile stripe includes tiles having the same subset of destination nodes.

17. The non-transitory machine-readable medium of claim 16, wherein dividing the graph data set into tiles comprises:
dividing the graph data set to balance compute for each of the tile stripes, wherein each of the tile stripes is expected to take a substantially same amount of processing.

18. The non-transitory machine-readable medium of claim 16, further comprising:
hashing tile stripe IDs for the tiles to generate a tile stripe ID hash map for each node of the graph data set.

19. The non-transitory machine-readable medium of claim 16, wherein:
a sum of degrees of the subset of destination nodes in a tile stripe is substantially the same for each of the tile stripes.

20. The non-transitory machine-readable medium of claim 14, further comprising:
receiving application-selected nodes, wherein the application-selected nodes include a subset of destination nodes of the graph data set to be processed.

21. The non-transitory machine-readable medium of claim 20, further comprising:
identifying tile stripe IDs of the application-selected nodes; and
sorting the application-selected nodes based on the tile stripe ID of the application-selected nodes.

22. The non-transitory machine-readable medium of claim 21, further comprising:
hashing tile stripe IDs for the tiles to generate a tile stripe ID hash map for each node of the graph data set; and
identifying the tile stripe IDs from the tile stripe ID hash map.

23. The non-transitory machine-readable medium of claim 21, further comprising:
dividing a subset of the graph data set including the sorted application-selected nodes into second tiles.

24. The non-transitory machine-readable medium of claim 23, further comprising:
causing each of the second tiles to be processed in parallel.

25. The non-transitory machine-readable medium of claim 14, further comprising:
prior to dividing a graph data set into tiles, reordering the graph data set, including:
performing a breadth first search on the graph data set with a node representing a center of the graph data set as a root node to generate a reordered graph data set, the reordered graph set including multiple levels;
selecting a subset of nodes from the last level of the reordered graph data set as candidate nodes;
with each of the candidate nodes as the root node, performing a breadth first search on the reordered graph data set to generate second reordered graph data sets; and
selecting one of the second reordered graph data sets for processing.
